(19) United States
(12) Patent Application Publication
(10) Pub. No.: US 2009/0139257 A1
(43) Pub. Date: Jun. 4, 2009

(54) Machine for making and dispensing frozen food products such as crushed-ice drinks, sorbets and the like

(76) Inventors: Gino Cocchi, Bologna (IT); Vicente Escriva Estruch, Gandia (ES)

Correspondence Address: Harbin King & Klima, 500 Ninth Street SE,, Washington, DC, 20003, US

(21) Appl. No.: 12/292,177

(22) Filed: Nov. 13, 2008

(30) Foreign Application Priority Data
Nov. 20, 2007 (IT) BO2007A 000763

(51) Int. Cl. A23G 9/00; F25B 39/02; F25D 23/00

(52) U.S. Cl. 62/342; 62/515; 62/259.1

(57) ABSTRACT

A machine for making and dispensing frozen food products such as crushed-ice drinks, sorbets and the like comprises a tank (3) for containing and processing the product to be dispensed, a dispensing tap (4) located close to the bottom of the tank (3), a motor-driven mixer element (11) and an evaporator (12) of a refrigerating circuit, the latter two items being housed inside the tank (3); the tank (3) has a lower chamber (5) and an upper chamber (7) which are separated from each other by a bottom wall (19) of the upper chamber (7); the lower chamber (5) houses the mixer element (11) and the evaporator (12), whilst the upper chamber (7) forms a well communicating with the lower chamber (5) so as to feed the latter; the substantially cylindrical lower chamber (5) is delimited by a wall (8) having at least one longitudinal rib (26) extending towards the inside of the lower chamber (5) and located in a position opposite and close to the unit consisting of the mixer element (11) and evaporator (12) assembly.

The present invention relates to a machine for making and dispensing frozen food products such as crushed-ice drinks, sorbets and the like.

Machines of this type, commonly known as crushed-ice drink makers or sorbet makers, usually comprise a transparent tank, for mixing and cooling a fluid which will be dispensed, in the form of a crushed-ice drink or sorbet, through a tap located close to the bottom of the tank.

The tank is closed at the top by a removable lid and houses, in its lower part, a mixer element of the screw type and an evaporator of a refrigerating circuit.

The tank usually has the shape of a parallelepiped, with the exception of its lower part, which is rounded in such a way that it partly envelops the substantially cylindrical perimeter of the mixer-evaporator unit and so prevents the formation of product stagnation zones.

Such machines are affected by slowness reaching the operating temperature, and therefore the operating state, from when they are started up, in particular if the tank is completely full of fluid.

Moreover, operations to top up the fluid which are necessary after dispensing product cause sudden changes in the temperature of the product already being processed, altering its crystalline structure. Also, although the mixer and the evaporator operate in conjunction with each other to guarantee the homogeneity of the product to be dispensed, the crushed-ice drink or the sorbet being fed out of the tap often have an irregular and excessive granularity, which is not very popular with the consumer.

In addition, after dispensing, above all in the case of two or more extractions in rapid succession, the product contained in the upper part of the tank is subjected to a disturbance which causes an undulation of its surface. This limits the effective containment capacity of the tank. The tank must be filled to below a level above which the surface undulations could entail an overflow of product.

The present invention has for an aim to provide a machine for making and dispensing frozen food products such as crushed-ice drinks, sorbets and the like which is able to dispense a product having a fine and homogeneous granularity.

The present invention also has for an aim to provide a machine for making and dispensing frozen food products such as crushed-ice drinks, sorbets and the like which rapidly reaches its operating state after being started up.

Another aim of the present invention is to provide a machine for making and dispensing frozen food products such as crushed-ice drinks, sorbets and the like which, during operation, is not very sensitive to top ups with fluid and/or to product extractions.

Accordingly, to achieve the above-mentioned aims, the present invention provides a machine for making and dispensing frozen food products such as crushed-ice drinks, sorbets and the like comprising the characteristics described in one or more of the claims herein.

The present invention is now described, by way of example and without limiting the scope of application, with reference to the accompanying drawings, in which:

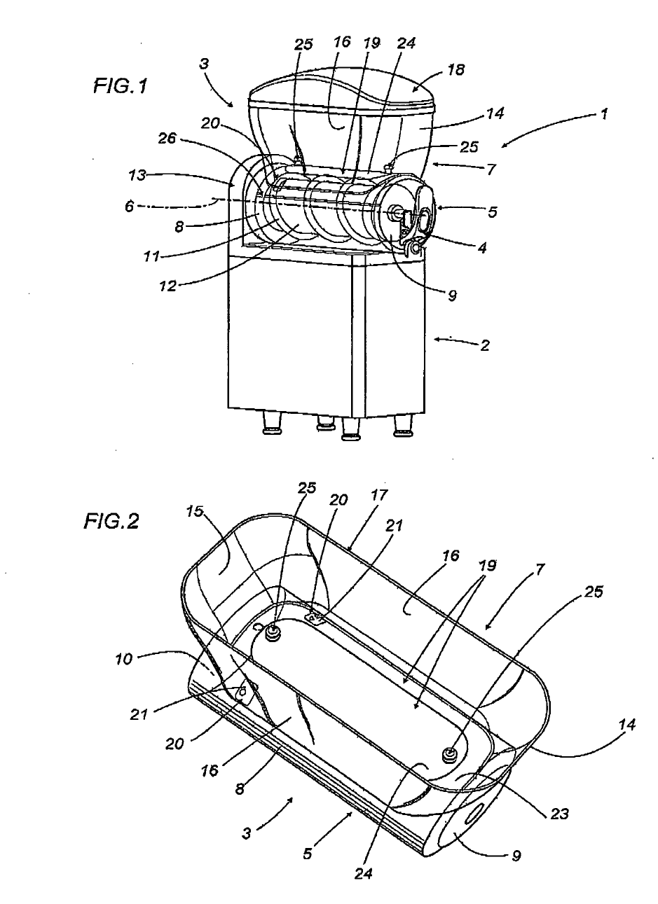

FIG. 1 is a perspective front view of a machine made in accordance with the present invention;

FIG. 2 is a perspective top view of a detail of the machine from FIG. 1;

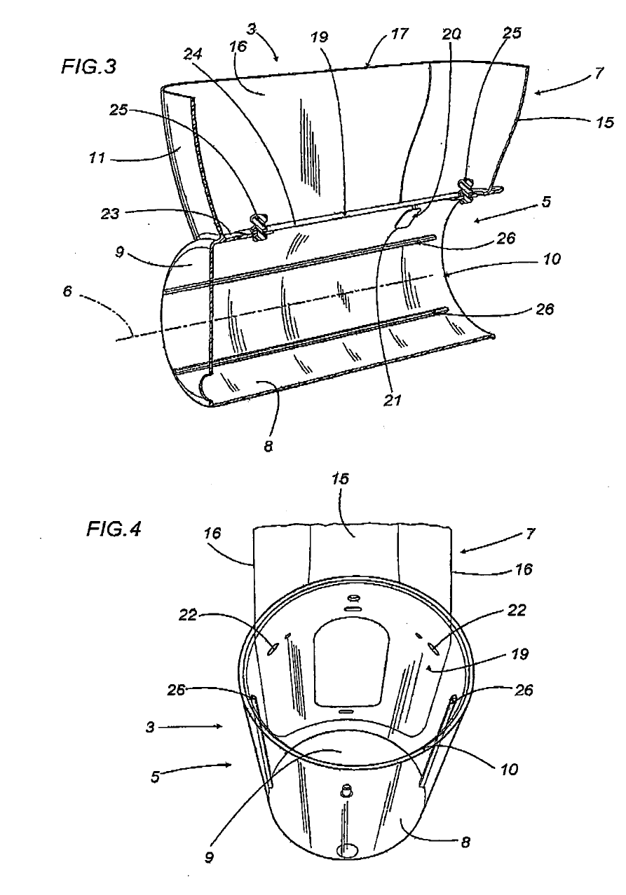

FIG. 3 is a perspective front view of a longitudinal section of the detail from FIG. 2;

FIG. 4 is a perspective bottom view with some parts cut away, of the detail from FIG. 2;

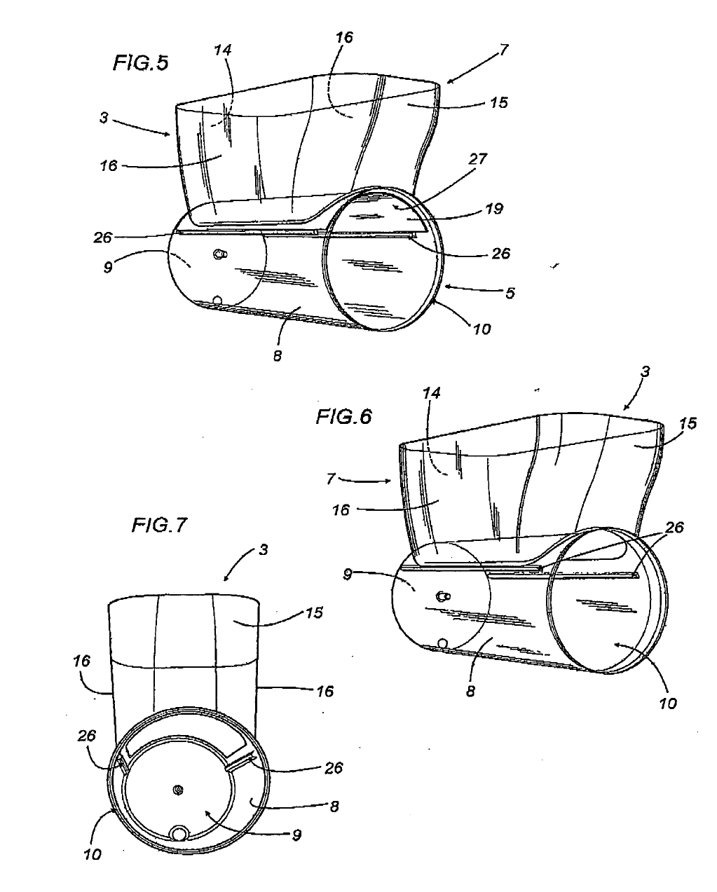

FIG. 5 is a perspective front view of a first alternative embodiment of the detail from FIG. 2;

FIG. 6 is a perspective front view of a second alternative embodiment of the detail from FIG. 2; and

FIG. 7 is a perspective bottom view of the detail from FIG. 6;

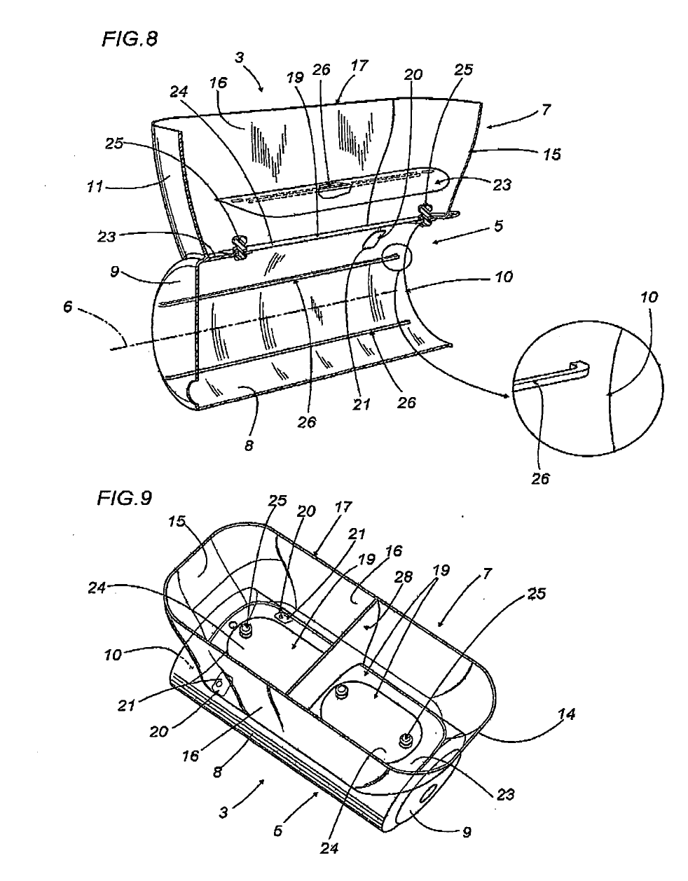

FIG. 8 is a perspective front view of a longitudinal section of the detail from FIG. 2 and relating to an alternative embodiment;

FIG. 9 is a perspective top view of a detail of the machine from FIG. 1, according to another alternative embodiment.

With reference to FIG. 1, the numeral 1 denotes as a whole a machine for making and dispensing frozen food products such as crushed-ice drinks, sorbets and the like.

The machine 1 comprises a base 2 housing a refrigerating circuit of the known type and not illustrated.

Mounted on the base 2 there is a transparent containment tank 3, for processing, specifically mixing and cooling, a fluid intended to be dispensed, in the form of a crushed-ice drink, sorbet or the like, through a tap 4 located close to the bottom of the tank 3.

The tank 3, better illustrated in FIGS. 2, 3 and 4, has a substantially cylindrical lower chamber 5, extending around a horizontal axis 6, and an upper chamber 7 which constitutes a mouth for loading the chamber 5 from above. The two chambers 5 and 7 are an integral part of the tank 3 which is therefore made as a single body.

As FIG. 3 shows more clearly, around the axis 6 the chamber 5 is delimited, at the bottom and the sides, by a single substantially tubular cylindrical wall 8, whilst, in the direction of the axis 6, the chamber 5 is delimited, at the front, by a wall 9, facing the operator and supporting the tap 4, and, at the rear, by an opening 10. The front wall 9 and the rear opening 10 are both circular.

The chamber 5 contains, and completely surrounds, a mixer element 11 of the screw type and an evaporator 12, the latter being part of the above-mentioned refrigerating circuit.

The mixer 11 is driven in rotation about the axis 6, and about the evaporator 12, by a motor, not illustrated, which is mounted on a shoulder 13 of the base 2 which seals the above-mentioned opening 10.

The upper chamber 7 substantially has the shape of a parallelepiped and is delimited by a front wall 14, facing the operator, by a rear wall 15 and by two lateral walls 16.

The upper opening 17 of the chamber 7 is closed by a removable lid 18.

The lower chamber 5 and the upper chamber 7 are separated from each other by a bottom wall 19 of the upper chamber 7.

The bottom wall 19 is curved according to a substantially cylindrical profile and guarantees continuity of shape for the lower chamber 5 between the upper ends of the above-mentioned wall 8.

The chambers 5 and 7 are put into communication with each other by holes 22 where valve means 20 may be mounted.

With valve means 20 inserted between them, the upper chamber 7 forms not just a loading mouth but also forms a well communicating with the lower chamber 5 so as to feed the latter. In other words, the well forms a storage and reserve chamber 7 for the product to be processed.

The valve means 20 comprise two elastic membranes 21 which close respective holes 22 in the bottom wall 19. The membranes 21, which may be present in a number other than two, allow fluid to pass only from the upper chamber 7 to the lower chamber 5, when a vacuum is created in the latter after one or more dispensing operations.

The bottom wall 19 has a first portion 23 made of a material with relatively low heat conductivity and a second portion 24 made of a material with relatively high heat conductivity. In particular, the first portion 23 is an integral part of the tank 3 and is made, for example, of plastic or glass, whilst the second portion 24 is fixed to the first portion 23 and is made of metal, for example of stainless steel.

The second portion 24 is removably fixed to the first portion 23 by pressure plugs 25, has a substantially rectangular shape and is located in a central position, that is to say, its entire perimeter is surrounded by the first portion 23.

The wall 8 of the lower chamber 5 has at least one projection 26 (FIG. 4 shows two of them), extending towards the inside of the lower chamber 5 and located in a position opposite and close to the unit consisting of the mixer element 11 and evaporator 12 assembly. Each projection 26 has the shape of a longitudinal rib extending parallel with the central longitudinal axis 6 of the lower chamber 5.

According to an embodiment not illustrated, the number of projections 26 is greater than two and they are evenly distributed around the axis 6, inside the lower chamber 5. Moreover, as FIG. 8 shows, the projection or projections 26 are made directly on the lower surface of the second portion 24 of the wall 19.

Moreover, as FIG. 8 shows, the projections 26 are made in such a way that they are detached from the inner wall of the lower chamber 5 and joined to the wall by respective spacers.

During machine 1 operation, the chamber 5 constitutes the true processing chamber for the product to be dispensed, and in it the mixer element 11 and the projections 26 operate in conjunction with each other to cause the product to move with a rotary motion away from and towards the front wall 9, in the direction of the axis 6.

Extraction of the product through the tap 4 creates a vacuum in the chamber 5, which causes the valve means 20 to open. Only at this point is the fluid contained in the chamber 7 drawn into the chamber 5 below.

Given the relatively compact dimensions of the chamber 5, and its partial heat insulation from the chamber 7, the machine 1 can rapidly reach the operating temperature, and therefore the operating state, after being started up, even if the tank 3 is completely full of fluid.

With regard to this, it should be noticed that the function of the metal portion 24 is to allow a pre-cooling of the fluid contained in the chamber 7, but without freezing it.

It should also be noticed that neither fluid top ups which are necessary in the chamber 7 after dispensing operations, nor the modest passage of fluid from the chamber 7 to the chamber 5 caused by the dispensing operations, suddenly change the temperature of the product already being processed in the chamber 5, and therefore the product being processed is not subjected to significant changes in its crystalline structure.

Added to this, in combination, is the action of the mixer element 11 and of the projections 26 which vigorously churn the product, making it homogeneous, with a fine and regular granularity. This gives the end product, whether it is a sorbet or a crushed-ice drink, a creaminess which is particularly popular with the consumer.

Moreover, the physical separation of the processing chamber 5 and the loading and reserve chamber 7, after dispensing, above all in the case of a number of extractions carried out in rapid succession, prevents the fluid contained in the upper part of the tank 3 from being subjected to unwanted surface undulation. Advantageously, this means that the chamber 7 can be filled completely without the risk that, after the above-mentioned undulation, the product may overflow from the tank 3.

According to the alternative embodiment illustrated in FIG. 5, the bottom wall 19 is completely made of metal, in particular stainless steel, and it consists of a separating plate 27 between the chambers 5 and 7. Obviously, in this case the heat exchange between the chamber 5 and the chamber 7 is greater than in the previous case. However, with respect to a greater heat inertia at start up, the machine 1 allows more frequent product extraction, since the liquid contained in the chamber 7 is colder than in the previous case.

According to the alternative embodiment illustrated in FIGS. 6 and 7, the bottom wall 19 is absent. However, in this case, the end product still has, although to a lesser extent, a creamy appearance, with a fine and regular granularity, thanks to the combined action of the mixer element 11 and the projections 26 which, as in the previous cases, vigorously churn the product.

Finally, according to an alternative embodiment illustrated in FIG. 9, the first upper chamber 7 has at least one partition wall 28 which is substantially perpendicular to the bottom wall 19 for dividing the upper chamber 7 into at least two portions so that two or more different products can be used in the same tank 3.

Moreover, according to an alternative embodiment not illustrated, the chamber 7 could be equipped with a mixer able to mix the product.

The invention described above is susceptible of industrial application and may be modified and adapted in several ways without thereby departing from the scope of the inventive concept. Moreover, all details of the invention may be substituted by technically equivalent elements.

1. A machine for making and dispensing frozen food products such as crushed-ice drinks, sorbets and the like, comprising a tank (3) for containing and processing the product to be dispensed, a dispensing tap (4) located close to the bottom of the tank (3), a motor-driven mixer element (11) and an evaporator (12) of a refrigerating circuit, the latter two items being housed inside the tank (3); the machine (1) being characterised in that the tank (3) has a lower chamber (5) and an upper chamber (7) which are separated from each other by a bottom wall (19) of the upper chamber (7); the lower chamber (5) housing the mixer element (11) and the evaporator (12), and the upper chamber (7) forming a well communicating with the lower chamber (5) so as to feed the latter.

2. The machine according to claim 1, characterised in that the lower chamber (5) has a substantially cylindrical shape; the bottom wall (19) being curved according to a substantially cylindrical profile.

3. The machine according to claim 2, characterised in that the lower chamber (5) completely surrounds the unit consisting of the mixer element (11) and evaporator (12) assembly.

4. The machine according to claim 4, characterised in that the lower and upper chambers (5,7) are put into communication with each other through one or more holes (22) made in the bottom wall (19) of the upper chamber (7).

5. The machine according to claim 4, characterised in that the lower and upper chambers (5,7) are put into communication with each other by inserting between them closing valve means (20) which can allow the passage of fluid only from the upper chamber to the lower chamber; there being the possibility of applying the valve means (20) at the holes.

6. The machine according to claim 5, characterised in that the bottom wall (19) is made of a heat-conductive material.

7. The machine according to claim 6, characterised in that the bottom wall (19) has a first portion (23) made of a material with relatively low heat conductivity and a second portion (24) made of a material with relatively high heat conductivity.

8. The machine according to claim 7, characterised in that the second portion (24) is located in a central position and its entire perimeter is surrounded by the first portion (23).

9. The machine according to claim 7, characterised in that the first portion (23) is an integral part of the tank (3), whilst the second portion (24) is fixed to the first portion (23) and can be removed from it.

10. The machine according to claim 9, characterised in that the lower chamber (5) is delimited by a wall (8) having at least one projection (26) extending towards the inside of the lower chamber (5) and located in a position opposite and close to the unit consisting of the mixer element (11) and evaporator (12) assembly.

11. The machine according to claim 2, characterised in that the projection (26) has the shape of a longitudinal rib extending parallel with the central longitudinal axis (6) of the lower chamber (5).

12. The machine according to claim 11, characterised in that it comprises a plurality of said projections (26), evenly distributed inside the lower chamber (5).

13. The machine according to claim 12, characterised in that the projection or projections (26) are made on the lower surface towards the second chamber of said removable second portion (24).

14. The machine according to claim 1, characterised in that the first upper chamber (7) has at least one partition wall (28) substantially perpendicular to the bottom wall (19) for dividing the upper chamber (7) into at least two portions.

15. A machine for making and dispensing frozen food products such as crushed-ice drinks, sorbets and the like, comprising a tank (3) for containing and processing the product to be dispensed, a dispensing tap (4) located close to the bottom of the tank (3), a motor-driven mixer element (11) and an evaporator (12) of a refrigerating circuit, the latter two items being housed inside the tank (3); the machine (1) being characterised in that, in a position opposite and close to the unit consisting of the mixer element (11) and evaporator (12) assembly, the tank (3) has at least one projection (26) extending towards the inside of the tank (3).

16. The machine according to claim 15, wherein the tank (3) has a substantially cylindrical lower chamber (5), housing the mixer element (11) and the evaporator (12), and an upper chamber (7) forming a well communicating with the lower chamber (5) so as to feed the latter, the machine being characterised in that the projection (26) has the shape of a longitudinal rib extending in the lower chamber (5) parallel with the central longitudinal axis (6) of the lower chamber (5).

17. The machine according to claim 16, characterised in that it comprises a plurality of said projections (26), evenly distributed inside the lower chamber (5).

18. The machine according to claim 16, characterised in that the lower chamber (5) and the upper chamber (7) are separated from each other by a bottom wall (19) of the upper chamber (7).

19. The machine according to claim 18, characterised in that the bottom wall (19) is curved according to a substantially cylindrical profile.

20. The machine according to claim 19, characterised in that the lower chamber (5) completely surrounds the unit consisting of the mixer element (11) and evaporator (12) assembly.

21. The machine according to claim 15, characterised in that the lower and upper chambers (5,7) are put into communication with each other through one or more holes made in the bottom wall (19) of the upper chamber (7).

22. The machine according to claim 15, characterised in that the lower and upper chambers (5,7) are put into communication with each other by inserting between them valve means (20); there being the possibility of mounting the valve means (20) at the holes.

23. The machine according to claim 17, characterised in that the bottom wall (19) is made of a heat-conductive material.

24. The machine according to claim 17, characterised in that the bottom wall (3) has a first portion (23) made of a material with relatively low heat conductivity and a second portion (24) made of a material with relatively high heat conductivity.

25. The machine according to claim 24, characterised in that the second portion (24) is located in a central position and its entire perimeter is surrounded by the first portion (23).

26. The machine according to claim 24, characterised in that the first portion (23) is an integral part of the tank, whilst the second portion (24) is fixed to the first portion (23) and can be removed from it.
